(19) United States
(12) Patent Application Publication
(10) Pub. No.: US 2025/0189851 A1
(43) Pub. Date: Jun. 12, 2025

(54) DISPLAY PANEL

(71) Applicant: Guangzhou China Star Optoelectronics Semiconductor Display Technology Co., Ltd., Guangzhou, Guangdong (CN)

(72) Inventors: Ru GE, Guangzhou, Guangdong (CN); Xiaobin HU, Guangzhou, Guangdong (CN)

(21) Appl. No.: 17/759,474

(22) PCT Filed: Jun. 8, 2022
(86) PCT No.: PCT/CN2022/097661

§ 371 Date: Jan. 16, 2025

(30) Foreign Application Priority Data
May 16, 2022 (CN) 202210533804.2

(51) Int. Cl. G02F 1/1343; G02F 1/1362; G02F 1/1368

(52) U.S. Cl. CPC G02F 1/134372; G02F 1/136286; G02F 1/1368

(57) ABSTRACT

A display panel is provided by the present application. The display panel includes a plurality of pixel electrodes; a plurality of data lines, each of the data lines is connected to each of the pixel electrodes; a first metal layer includes a common electrode line and at least one first common electrode, and the common electrode line at least partially overlaps the first common electrodes, the first common electrodes are disposed below the data lines and connected to the common electrode line.

### FIELD OF INVENTION

The present application relates to a field of display, and in particular to a display panel.

### BACKGROUND ART

Fringe field switching (FFS) type liquid crystal display panels have advantages of high penetration and wide viewing angle and have been widely used in small and medium-sized display devices, especially mobile phone panels. The FFS type liquid crystal display panels use a boundary electric field to make liquid crystal (LC) molecules in a liquid crystal cell (cell) rotate in a plane parallel to a substrate, resulting in an optical path difference, and under an action of an upper and lower polarizers, a display effect is achieved.

### SUMMARY OF THE INVENTION

### Technical Problems

However, in an existing pixel design, there is capacitive coupling between data lines and pixels, which creates a crosstalk risk, thereby affecting the display effect of a picture.

### Solutions to Problems

### Technical Proposals

Embodiments of the present application provide a display panel, which can improve a problem of crosstalk risk in an existing display panel.

The present application provides a display panel, the display panel includes:
a plurality of pixel electrodes;
a plurality of data lines, each of the data lines is connected to one of the pixel electrodes; and
a first metal layer, comprising a common electrode line and at least one first common electrode, the common electrode line at least partially overlaps with the pixel electrodes, and the first common electrodes are disposed below the data lines and connected with the common electrode line.

### BENEFICIAL EFFECTS OF INVENTION

### Beneficial Effects

Beneficial effects of the present application are as follows: the present application provides a display panel, the display panel includes a plurality of pixel electrodes, a plurality of data lines, and a first metal layer, each of the data lines is connected to each of the pixel electrodes, the first metal layer includes a common electrode line and at least one first common electrodes, the common electrode line at least partially couples with the pixel electrodes, and the first common electrodes are disposed below the data lines and connected to the common electrode line. By disposing the first common electrodes below the data lines, a capacitance between the pixel electrodes and the common electrode line is increased, so that a storage capacitance of pixel can be increased, while a capacitance between the pixel electrodes and the data lines remains unchanged, so that a ratio of the capacitance between the data lines and the pixel electrodes to a total capacitance of the display panel is reduced, therefore, it is more difficult for the pixel to be affected by a voltage of the data lines, in this way, the capacitive coupling of the data lines to the pixel is reduced, and the crosstalk risk is reduced.

### BRIEF DESCRIPTION OF DRAWINGS

### Description of Drawings

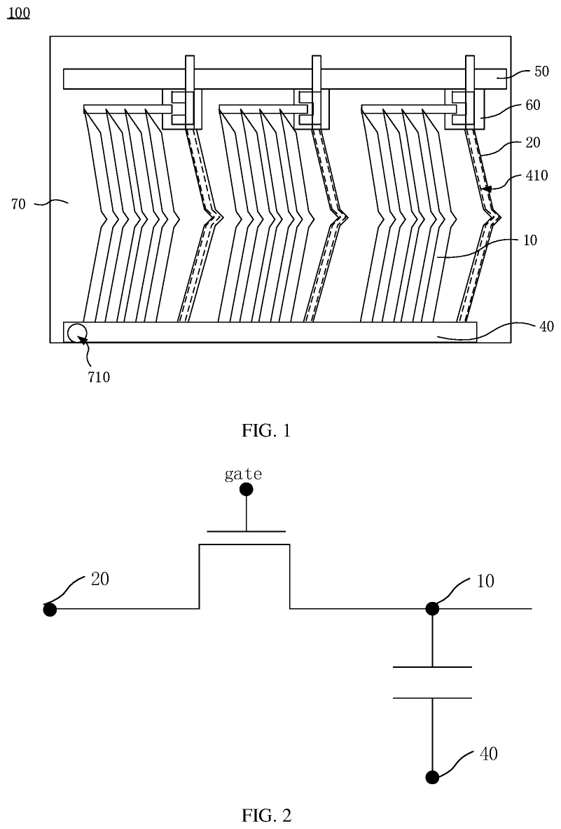

FIG. 1 is a first schematic structural diagram of a display panel provided by an embodiment of the present application.

FIG. 2 is a schematic structural diagram of a partial circuit structure of pixel electrodes provided by an embodiment of the present application.

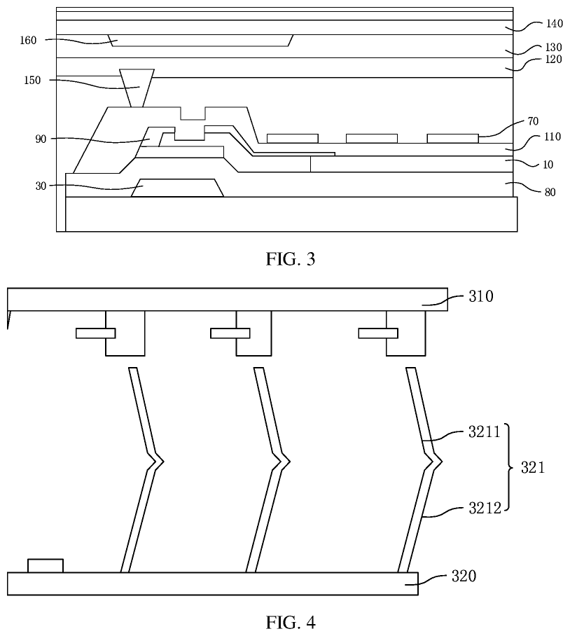

FIG. 3 is a second schematic structural diagram of the display panel provided by an embodiment of the present application.

FIG. 4 is a schematic structural diagram of a first metal layer in the display panel shown in FIG. 1.

### EMBODIMENTS OF INVENTION

### Implementation Modes of the Invention

The technical solutions in the embodiments of the present application will be clearly and completely described below with reference to the drawings in the embodiments of the present application. Obviously, the described embodiments are only a part of the embodiments of the present application, but not all of the embodiments. Based on the embodiments in this application, all other embodiments obtained by those skilled in the art without creative work shall fall within the protection scope of this application.

In the description of the present application, it is to be understood that the azimuth or positional relationships indicated by the terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counter-clockwise”, etc., are based on the azimuth or positional relationship shown in the drawings, merely for the purpose of assisting and simplifying the description, rather than indicating or implying that the indicated device or element must have a specific orientation, and be constructed and operated in a particular orientation. Therefore, these terms cannot be construed as limiting the present disclosure. In addition, the terms “first” and “second” are only configured for descriptive purposes, and cannot be understood as indicating or implying relative importance or implicitly indicating the number of indicated technical features. Therefore, the features defined with “first” and “second” may explicitly or implicitly include one or more of the features. In the description of the present application, “a plurality of” means two or more than two, unless otherwise specifically defined.

Fringe field switching (FFS) liquid crystal displays have a wide range of applications. In an existing pixel design, a pixel structure of flip pixel is generally used, in an application of high refresh rate and high resolution, a sub-pixel (RGB stripe) structure can achieve a higher charging rate, due to there are capacitive couplings between data lines and pixels of the RGB stripe structure in a vertical display, a crosstalk risk is larger.

Therefore, in order to solve the above problems, the present application proposes a display panel. The present application will be further described below with reference to the drawings and embodiments.

Please refer to FIG. 1 and FIG. 2, FIG. 1 is a first schematic structural diagram of a display panel provided by an embodiment of the present application. FIG. 2 is a schematic structural diagram of a partial circuit structure of pixel electrodes provided by an embodiment of the present application. An embodiment of the present application provides a display panel 100, the display panel 100 includes a plurality of pixel electrodes 10, a plurality of data lines 20, and a first metal layer, wherein each of the data lines 20 is connected to each of the pixel electrodes 10 and is used to transmit data signals to corresponding pixel electrodes 10. The first metal layer includes a common electrode line 40 and at least one first common electrode 410, the common electrode line 40 at least partially overlaps the pixel electrodes 10. The first common electrodes 410 are disposed below the data lines 20 and are connected to the common electrode line 40. By disposing the first common electrodes 410 below the data lines 20, a capacitance between the pixel electrodes 10 and the common electrode line 40 is increased, so that a storage capacitance of a pixel can be increased, while a capacitance between the pixel electrodes 10 and the data lines 20 remains unchanged, so that a ratio of a capacitance between the data lines 20 and the pixel electrodes 10 to a total capacitance of the display panel is reduced, therefore, it is more difficult for the pixel to be affected by a voltage of the data lines 20, in this way, capacitive coupling of the data lines 20 to the pixels is reduced, and a crosstalk risk is reduced.

Wherein, an orthographic projection of the first common electrodes 410 is within an orthographic projection of the data lines 20. Exemplarily, a width of one of the first common electrodes 410 can be less than or equal to a width of one of the data lines 20. In other embodiments, in order to better reduce the crosstalk risk, the width of one of the first common electrodes 410 can also be greater than the width of one of the data lines 20. The width of one of the first common electrodes 410 needs to be set according to an actual situation, and it is not specifically limited to these.

In some embodiments, a number of the first common electrodes 410 is less than a number of the data lines 20. In other embodiments, in order to better reduce a crosstalk of the data lines 20 to the display panel 100, the first common electrodes 410 can be disposed below each of the data lines 20, that is, the number of the first common electrodes 410 is equal to the number of the data lines 20.

Wherein, the first metal layer further includes a gate line 50, and a width of the gate line 50 is less than a width of the common electrode line 40. An end of each of the first common electrodes is connected to the common electrode line, and the other end of each of the first common electrodes extends toward a direction adjacent to the gate line, and there is a gap between each of the first common electrodes and the gate line.

Please continue to FIG. 2, in some embodiments, under a condition of ensuring a pixel aperture ratio, the first metal layer further includes at least one second common electrode, the second common electrodes are disposed below the pixel electrodes 10, and the second common electrodes are connected to the pixel electrodes 10, the second common electrodes are disposed at a same layer as the common electrode line 40, and the second common electrodes are connected to the common electrode line 40. By disposing the second common electrodes below the pixel electrodes 10, the capacitance between the pixel electrodes 10 and the common electrode line 40 is increased, so that the storage capacitance of the pixel can be increased, while the capacitance between the pixel electrodes 10 and the data lines 20 remains unchanged, so that the ratio of the capacitance of the data lines 20 to the pixel electrodes 10 in the total capacitance of the display panel is reduced, therefore, it is more difficult for the pixel to be affected by the voltage of the data lines 20, in this way, the capacitive coupling of the data lines 20 to the pixel is reduced, and the crosstalk risk is reduced.

In some embodiments, in order to ensure the aperture ratio of the pixel electrodes 10, the second common electrodes can be disposed close to edges of the pixel electrodes 10, so as to not only ensure the aperture ratio of the pixel electrodes 10, but also increase the capacitance between the pixel electrodes 10 and the common electrode line 40, thereby reducing the capacitive coupling of the data lines 20 to the pixel.

In some other embodiments, in order to better ensure the aperture ratio of the pixel electrodes 10, the width of one of the first common electrodes can be appropriately increased and the width of corresponding second common electrodes can be decreased, that is, the width of the first common electrodes is greater than the width of the second common electrodes.

It can be understood that the second common electrodes are disposed in parallel with the first common electrodes.

Wherein, an end of each of the second common electrodes is connected to the common electrode line, the other end of each of the second common electrodes extends away from the common electrode line, and there is a gap between the other end of each of the second common electrodes and the gate line.

In some embodiments, the first metal layer further includes at least one third common electrode and the gate line 50, the gate line 50 is disposed at an end of the data lines 20 away from the common electrode line 40, and the third common electrodes are connected to the common electrode line 40, the third common electrodes and the common electrode line 40 are disposed at a same layer, and the third common electrodes are disposed in a second direction opposite to a first direction, so that a width of the gate line 50 is less than a width of the common electrode line 40. By increasing an area of the common electrode line 40, the capacitance between the pixel electrodes 10 and the common electrode line 40 is increased, so that the storage capacitance of the pixel can be increased, while the capacitance between the pixel electrodes 10 and the data lines 20 remains unchanged, so that the ratio of the capacitance of the data lines 20 to the pixel electrodes 10 in the total capacitance of the display panel is reduced, therefore, it is more difficult for the pixel to be affected by the voltage of the data lines 20, in this way, the capacitive coupling of the data lines 20 to the pixel is reduced, and the crosstalk risk is reduced.

Wherein, the first direction is a direction of the common electrode line 40 facing the gate line 50, and the second direction is a direction of the gate line 50 facing the common electrode line 40.

It should be noted that in order to save a process, the gate line 50, the common electrode line 40, and the first common electrodes 410 are formed in a same process.

It can be understood that to reduce the crosstalk risk, the first common electrodes 410 can be disposed below the data lines 20, or the first common electrodes 410 can be disposed below the pixel electrodes 10, or the first common electrodes 410 can be disposed at a same layer as the common electrode line 40. Specific option are selected according to actual situations, and there is no specific limitation to these.

It should be noted that since all of the first common electrodes 410, the second common electrodes, and the third common electrodes belong to a same metal layer as the common electrode line 40, and the first common electrodes 410, the second common electrodes, and the third common electrodes are connected to the common electrode line 40, therefore, when fabricating the first common electrodes 410, the second common electrodes, or the third common electrodes, all of the first common electrodes 410, the second common electrodes, or the third common electrodes are fabricated in a same process as the common electrode line 40.

Materials of the common electrode line 40, the first common electrodes 410, the second common electrodes, and the third common electrodes are one of aluminum or molybdenum-chromium, or molybdenum, aluminum, molybdenum, or a material of molybdenum, aluminum, and molybdenum stacked in sequence. In some embodiments, in order to save material resources, the materials of the common electrode line 40, the materials of the first common electrodes 410, the materials of the second common electrodes, and the materials of the third common electrodes are same. In some other embodiments, the materials of the common electrode line 40, the materials of the first common electrodes 410, the materials of the second common electrodes, and the materials of the third common electrodes are not all the same. It can be understood that this embodiment of the present application does not specifically limit this, and specific root and the actual situation may be set.

As seen from FIG. 2, in order to further reduce the crosstalk, the first common electrodes 410 can also be disposed at other places at the same layer as the common electrode line 40, as long as that the first common electrodes 410 disposed at the same layer as the common electrode line 40 is satisfied, and the first common electrodes 410 are connected to the common electrode line 40, which can be specifically set according to the actual situation, which is not specifically limited to these.

The display panel 100 further includes a second metal layer 90, and the second metal layer 90 forms the above-mentioned data lines 20.

Please continue to refer to FIG. 3, FIG. 3 is a second schematic structural diagram of the display panel provided by an embodiment of the present application. The display panel 100 further includes an indium tin oxide (ITO) layer, the ITO layer includes a fifth common electrode 70, and the fifth common electrode 70 is disposed above the common electrode line 40, a layer between the fifth common electrode 70 and the common electrode line 40 is defined with a via hole 710, and the fifth common electrode 70 is electrically connected to the common electrode line 40 through a wire in the via hole 710.

The display panel 100 further includes the gate line 50 and at least one thin film transistor 60, a gate electrode of one of the thin film transistors 60 is connected to the gate line 50, a source electrode of one of the thin film transistors 60 is connected to one of the data lines 20, and a drain electrode of one of the thin film transistors 60 is connected to one of the pixel electrodes 10.

Wherein, the gate electrode of one of the thin film transistors 60 is formed by the first metal layer 30, and the source electrode of the one of the thin film transistors 60 and the drain electrode of the one of the thin film transistors 60 are formed by the second metal layer 90.

The display panel 100 further includes a gate insulating layer 80, the gate insulating layer 80 is disposed between the first metal layer 30 and the second metal layer 90.

When fabricating the display panel 100, the first metal layer 30 is fabricated to form the common electrode line 40 firstly, then the gate insulating layer 80 is fabricated on the first metal layer 30, and then the second metal layer 90 is fabricated on the gate insulating layer 80 to form the plurality of data lines 20. Then, the pixel electrodes 10 are fabricated, and then a planarization layer is fabricated to form the fifth common electrode 70.

The display panel 100 further includes a passivation layer 110, the passivation layer 110 is disposed on a surface of the pixel electrodes 10 away from the gate insulating layer 80, and a material of the passivation layer 110 is silicon nitride, silicon oxide, or a combination thereof.

The display panel 100 further includes an insulating cover (over coating, OC) layer 120, the insulating cover layer 120 is disposed on a surface of the fifth common electrode 70 away from the pixel electrodes 10, and a material of the insulating cover layer 120 can be a gel coat resin.

The display panel 100 further includes a color filter 130, and the color filter 130 is disposed on a surface of the insulating cover layer 120 away from the fifth common electrode 70.

The display panel 100 further includes a substrate layer 140. The substrate layer 140 is disposed on a side of the color filter 130 away from the insulating cover layer 120, the substrate layer 140 can include a glass substrate layer or a flexible substrate layer.

The display panel 100 further includes a support column 150.

The display panel 100 further includes a light shielding layer 160, and a material of the light shielding layer 160 can be black ink.

Please continue to refer to FIG. 4, FIG. 4 is a schematic structural diagram of the first metal layer in the display panel shown in FIG. 1. The first metal layer 30 includes a first portion 310 and a second portion 320 disposed at intervals, the second portion 320 includes a plurality of first branches 321 disposed in the first direction, the plurality of first branches 321 are disposed in an interval region of adjacent two groups of pixel electrodes, and the data lines 20 are provided with the first branches 321. The first portion 310 is used to form the gate line 50, the second portion 320 is used to form the common electrode line 40 and the first common electrodes 410, wherein the first branches 321 form the first common electrodes 410.

Each of the first branches 321 includes a first sub-branch 3211 and a second sub-branch 3212, the first sub-branch 3211 and the second sub-branch 3212 are bent relative to each other in a direction from the common electrode line 40 to the gate line 50, each of the first common electrodes 410 includes a first part and a second part, and there is an angle greater than zero degree between the first part and the second part, that is, the first part and the second part are bent relative to each other, and a viewing angle can be improved by a bending.

In this embodiment of the present application, at least one first common electrode 410 is disposed below the data lines 20, and the first common electrodes 410 are disposed in the same layer as the common electrode line 40 and connected to the common electrode line 40, the capacitance between the pixel electrodes 10 and the common electrode line 40 is increased, so that the storage capacitance of pixel can be increased, while the capacitance between the pixel electrodes 10 and the data lines 20 remains unchanged, so that the ratio of the capacitance of the data lines 20 to the pixel electrodes 10 in the total capacitance of the display panel is reduced, therefore, it is more difficult for the pixel to be affected by the voltage of the data lines 20, in this way, the capacitive coupling of the data lines 20 to the pixels is reduced, and the crosstalk risk is reduced. And under the condition of ensuring the pixel aperture ratio, the second common electrodes can also be set below the pixel electrodes 10 or the third common electrodes can be set on the same layer as the common electrode line 40, the capacitance between the pixel electrodes 10 and the common electrode line 40 is further increased, so that the capacitance of the data lines 20 to the pixel electrodes 10 is reduced in an overall pixel ratio, thereby reducing the capacitive coupling of the data lines 20 to the pixel, and the crosstalk risk is reduced.

The display panel provided by the embodiments of the present application has been described in detail above. The principles and implementations of the present application are described herein by using specific examples, and the descriptions of the above embodiments are only used to help understanding of the present application. At the same time, for those skilled in the art, according to the idea of the present application, there will be changes in the specific embodiments and application scope. To sum up, the content of this description should not be construed as a limitation to the present application.

What is claimed is:

1. A display panel, wherein the display panel comprises:
a plurality of pixel electrodes;
a plurality of data lines, each of the data lines connected to one of the pixel electrodes; and
a first metal layer, comprising a common electrode line and at least one first common electrode, the common electrode line at least partially overlaps the pixel electrodes, and the first common electrodes are disposed below the data lines and connected with the common electrode line.

2. The display panel according to claim 1, wherein each of the first common electrodes comprises a first part and a second part, and there is an angle between the first part and the second part.

3. The display panel according to claim 1, wherein an orthographic projection of the first common electrodes is within an orthographic projection of the data lines.

4. The display panel according to claim 1, wherein the first metal layer further comprises:
a gate line, a width of the gate line is less than a width of the common electrode line.

5. The display panel according to claim 4, wherein an end of each of the first common electrodes is connected to the common electrode line, and the other end of each of the first common electrodes extends toward the gate line, and a gap is defined between each of the first common electrodes and the gate line.

6. The display panel according to claim 5, wherein the first metal layer further comprises:
at least one second common electrode, the second common electrodes disposed below the pixel electrodes, and the second common electrodes are connected to the common electrode line.

7. The display panel according to claim 6, wherein the second common electrodes are disposed adjacent to edges of the pixel electrodes.

8. The display panel according to claim 6, wherein a width of one of the first common electrodes is greater than a width of one of the second common electrodes.

9. The display panel according to claim 6, wherein an end of one of the second common electrodes is connected to the common electrode line, and the other end of one of the second common electrodes extends in a direction away from the common electrode line.

10. The display panel according to claim 6, wherein the display panel further comprises at least one third common electrode, the third common electrodes are disposed above the common electrode line, and a via hole is defined between one of the third common electrodes and the common electrode line, one of the third common electrodes is electrically connected to the common electrode line through a wire in the via hole.

11. The display panel according to claim 10, wherein a material of the common electrode line, materials of the first common electrodes, materials of the second common electrodes, and materials of the third common electrodes are the same.

12. The display panel according to claim 6, wherein the gate line, the first common electrodes, and the second common electrodes are formed in a same process.

13. The display panel according to claim 6, wherein the second common electrodes are disposed in parallel with the first common electrodes.

14. The display panel according to claim 6, wherein a number of the second common electrodes is equal to a number of the data lines.

15. The display panel according to claim 6, wherein a width of one of the second common electrodes is less than or equal to a width of one of the data lines.

16. The display panel according to claim 6, wherein the display panel further comprises at least one thin film transistor, a gate electrode of one of the thin film transistors is connected to the gate line, a source electrode of one of the thin film transistors is connected to one of the data lines, and a drain electrode of one of the thin film transistors is connected to one of the pixel electrodes.

17. The display panel according to claim 1, wherein the first metal layer comprises a first portion and a second portion disposed at intervals, the second portion comprises a plurality of first branches disposed in a first direction, the plurality of first branches are disposed in an interval region of adjacent two groups of pixel electrodes, and each of the first branches is provided with one of the data lines.

18. The display panel according to claim 1, wherein a number of the first common electrodes is less than or equal to a number of the data lines.

19. The display panel according to claim 1, wherein materials of the first common electrodes are one of aluminum, molybdenum, chromium, or a structure of molybdenum, aluminum, and molybdenum stacked in sequence.

20. The display panel according to claim 1, wherein the display panel further comprises a second metal layer, and the second metal layer is used to form the data lines.
